(19) United States
(12) Patent Application Publication
(10) Pub. No.: US 2008/0154405 A1
(43) Pub. Date: Jun. 26, 2008

(54) AUDIO SYSTEM

(75) Inventors: AI-MIN CHEN, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (Shenzhen) CO., LTD., Shenzhen City (CN); HON HAI PRECISION INDUSTRY CO., LTD., Tu-Cheng (TW)

(21) Appl. No.: 11/836,797

(22) Filed: Aug. 10, 2007

(30) Foreign Application Priority Data
Dec. 26, 2006 (CN) 200610201407.6

(51) Int. Cl. G06F 17/00

(52) U.S. Cl. 700/94

(57) ABSTRACT

An audio system includes a microprocessor, a digital/analog converter, an amplifier circuit, a feedback circuit, a switch circuit, and an output interface. The digital/analog converter converts digital audio signals from the microprocessor to analog audio signals. The amplifier circuit amplifies the analog audio signals. The feedback circuit controls the amplitude of the amplified analog audio signals. The switch circuit is connected between the amplifier circuit and the output interface and connected to the microprocessor. When the microprocessor does not output digital audio signals, the microprocessor outputs a controlling signal to control the switch circuit to turn off such that the amplifier circuit is disconnected from the output interface.

### BACKGROUND

1. Field of the Invention

The present invention relates to an audio system of a digital apparatus.

2. Description of Related Art

An audio system used in a digital apparatus is capable of selectively providing an amplified audio signal to a local speaker and/or a remote speaker without the use of transformers or relays. Additionally, the system is capable of increasing the level of audio power that it delivers to a speaker, or muting all audio output in response to microprocessor control signals.

Referring to FIG. 2, a conventional audio system in a digital apparatus includes a microprocessor 1, a digital/analog converter 2, an amplifier circuit 3, a feedback circuit 4, and an output interface 5. The microprocessor 1 outputs a digital audio signal to the digital/analog converter 2. The digital/analog converter 2 converts the digital audio signal to an analog audio signal. The amplifier circuit 3 amplifies the analog audio signal. The feedback circuit controls the amplitude of the amplified analog audio signal. The output interface 5 is configured to increase an output power of the audio system. The output interface 5 includes a plurality of ground-capacitors therein, for compensating the loss of harmonic distortion when the output interface 5 transmits the amplified analog audio signal to an audio connector, which is further connected to a speaker. However, noise from other circuits of the digital apparatus can be coupled to an output of the amplifier circuit 3 via the ground-capacitors of the output interface 5, then fed back to an input of the amplifier circuit 3, amplified by the amplifier circuit 3, and finally output by the output interface 5, which results in reduced signal to noise ratio.

What is needed, therefore, is an audio system with increased signal to noise ratio.

### SUMMARY

An audio system for providing an amplified audio signal is provided. In an embodiment, the audio system includes a microprocessor, a digital/analog converter, an amplifier circuit, a feedback circuit, a switch circuit, and an output interface. The microprocessor includes an output port and a control port. The control port provides a first controlling signal when the output port outputs digital audio signals. The control port provides a second controlling signal when the output port does not output digital audio signals. The digital/analog converter is connected to the output port of the microprocessor, for converting digital audio signals to analog audio signals. The amplifier circuit is configured for amplifying analog audio signals. The feedback circuit is connected between an output of the amplifier circuit and an input of the amplifier circuit, for controlling the amplitude of the amplified analog audio signals. The switch circuit is connected between the output of the amplifier circuit and the output interface and connected to the control port of the microprocessor. When the switch circuit receives the first controlling signal, the switch circuit turns on and delivers the amplified analog audio signals to the output interface. When the switch circuit receives the second controlling signal, the switch circuit turns off, and the amplifier circuit is disconnected from the output interface.

Other advantages and novel features will become more apparent from the following detailed description when taken in conjunction with the accompanying drawings, in which:

### BRIEF DESCRIPTION OF THE DRAWINGS

FIG. 1 is a block diagram of an audio system in accordance with an embodiment of the present invention; and

FIG. 2 is a block diagram of a conventional audio system.

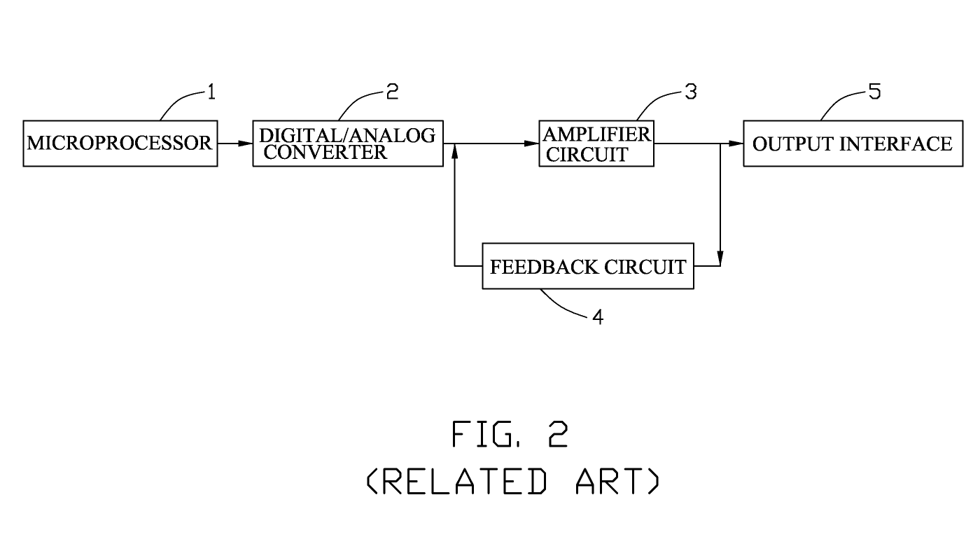

### DETAILED DESCRIPTION

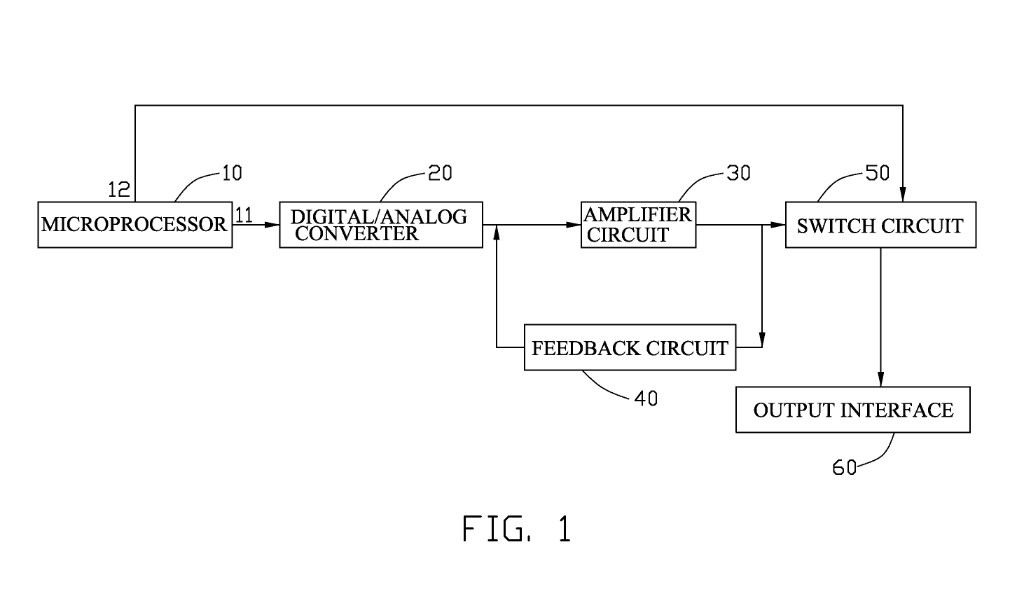

Referring to FIG. 1, an audio system in accordance with an embodiment of the present invention includes a microprocessor 10, a digital/analog converter 20, an amplifier circuit 30, a feedback circuit 40, a switch circuit 50, and an output interface 60.

The microprocessor 10 includes an output port 11 and a control port 12. The control port 12 provides a first controlling signal when the output port 11 outputs a digital audio signal. The control port 12 provides a second controlling signal when the output port 11 does not output a digital audio signal. An input of the digital/analog converter 20 is connected to the output port 11 of the microprocessor 10. An output of the digital/analog converter 20 is connected to an input of the amplifier circuit 30. The feedback circuit 40 is connected between an output of the amplifier circuit 30 and the input of the amplifier circuit 30. The switch circuit 50 includes an input connected to the output of the amplifier circuit 30, an output connected to the output interface 60, and a control terminal connected to the control port 12 of the microprocessor 10. The switch circuit 50 can be a bipolar junction transistor or a MOSFET.

In operation, when the output port 11 of the microprocessor 10 outputs a digital audio signal, the digital/analog converter 20 converts the digital audio signal to an analog audio signal. The amplifier circuit 30 amplifies the analog audio signal. The feedback circuit 40 controls the amplitude of the amplified analog audio signal. The switch circuit 50 receives the first controlling signal output by the control port 12 of the microprocessor 10, and turns on. The amplified analog audio signal is thereby delivered to the output interface 60 via the switch circuit 50. The output interface 60 delivers the amplified analog audio signal to an audio connector (not shown) and increases an output power of the audio system. The output interface 60 includes a plurality of ground-capacitors therein, for compensating for loss through harmonic distortion when the output interface 60 delivers the amplified analog audio signal to the audio connector. When the output port 11 of the microprocessor 10 does not output a digital audio signal, the switch circuit 50 receives the second controlling signal output by the control port 12 of the microprocessor 10, and turns off. Therefore, the amplifier circuit 30 is disconnected from the output interface 60. Noise from other circuits of the digital apparatus are not coupled to the output of the amplifier circuit 30 via the ground-capacitors of the output interface 60, fed back to the input of the amplifier circuit 30, and amplified by the amplifier circuit 30.

A method of testing signal to noise ratio (SNR) of the audio system is as follows: Firstly, the output interface 60 is connected to an audio analyzer. Secondly, the control port 12 of the microprocessor 10 outputs the first controlling signal to turn on the switch circuit 50, and the microprocessor 10 controls the output interface 60 to output a 1 kHz sine wave signal to the audio analyzer, such that the audio analyzer gets a reference signal. Thirdly, the microprocessor is controlled not to output a digital audio signal such that the audio analyzer gets a noise signal. The SNR is, by definition, 20 times the logarithm of the amplitude ratio between the reference signal and the noise signal. Compared to the conventional art, when the microprocessor 10 does not output a digital audio signal, the amplifier circuit 30 is disconnected from the output interface 60 such that the amplitude of the noise signal is reduced. Therefore, the SNR of the audio system is increased according to the definition of SNR.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An audio system comprising:
a microprocessor comprising an output port and a control port, the control port providing a first controlling signal when the output port outputs a digital audio signal, the control port providing a second controlling signal when the output port does not output a digital audio signal;
a digital/analog converter connected to the output port of the microprocessor, for converting digital audio signals to analog audio signals;
an amplifier circuit for amplifying the analog audio signals;
a feedback circuit connected between an output of the amplifier circuit and an input of the amplifier circuit, for controlling the amplitude of the amplified analog audio signals;
an output interface; and
a switch circuit connected between the output of the amplifier circuit and the output interface and connected to the control port of the microprocessor, wherein when the switch circuit receives the first controlling signal, the switch circuit turns on and delivers the amplified analog audio signals to the output interface, when the switch circuit receives the second controlling signal, the switch circuit turns off, and the amplifier circuit is disconnected from the output interface.

2. The audio system as claimed in claim 1, wherein the output interface is configured to deliver the amplified analog audio signals to an audio connector and increase an output power of the audio system.

3. The audio system as claimed in claim 2, wherein the output interface comprises a plurality of ground-capacitors therein, for compensating loss from harmonic distortion when the output interface delivers the amplified analog audio signals to the audio connector.

4. The audio system as claimed in claim 1, wherein the switch circuit is a bipolar junction transistor or a MOSFET.

5. An audio system comprising:
a microprocessor comprising an output port and a control port, the control port providing a first controlling signal when the output port outputs a digital audio signal, the control port providing a second controlling signal when the output port does not output a digital audio signal;
a digital/analog converter connected to the output port of the microprocessor, for converting digital audio signals to analog audio signals;
an amplifier circuit for amplifying the analog audio signals;
a feedback circuit for controlling the amplitude of the amplified analog audio signals; and
a switch circuit connected to the control port of the microprocessor and the output of the amplifier, wherein when the switch circuit receives the first controlling signal, the switch circuit turns on and delivers the amplified analog audio signals to an output interface of the audio system, when the switch circuit receives the second controlling signal, the switch circuit turns off, and the amplifier circuit is disconnected from the output interface.

6. The audio system as claimed in claim 5, wherein the switch circuit is a bipolar junction transistor or a MOSFET.
